(19) United States
(12) Patent Application Publication
(10) Pub. No.: US 2019/0150458 A1
(43) Pub. Date: May 23, 2019

(54) Food pasta made from dururm wheat semolina and vegetables and processes for manufacture thereof

(71) Applicant: Ottavio Natali, Budrio (BO) (IT)

(72) Inventor: Ottavio Natali, Budrio (BO) (IT)

(21) Appl. No.: 16/315,619

(22) PCT Filed: Jul. 20, 2016
(86) PCT No.: PCT/IT2016/000178

§ 371 Date: Jan. 4, 2019

(51) Int. Cl. A21D 13/02; A21D 2/36; A21C 11/16

(52) U.S. Cl. CPC A21D 13/02; A23L 7/109; A21C 11/16; A21D 2/36

(57) ABSTRACT

A special pasta is substantially constituted by a mixture of durum wheat semolina and of vegetables. Further, this pasta can also be pre-salted. A procedure for the preparation of this pasta and uses thereof are also disclosed.

### TECHNICAL FIELD

The present invention refers to a special pasta substantially constituted by a mixture of durum wheat semolina and vegetables.

Further, said pasta can also be pre-salted.

The present invention refers also to a procedure for the preparation of said pasta and the uses thereof.

### BACKGROUND ART

Varied are the types of food pasta in commerce, in which said pastas have different compositional, food and format features.

Just as a way of example, a reference classification (that will be followed in the present description) of the food pasta is reported in the Italian regulations, precisely in the Presidential decree no. 187/2001, subsequently modified by the Presidential decree no. 41/2013. With reference to said regulations, the pasta of the present invention falls within the category “SPECIAL PASTAS” (Art. 7) and, specifically, it is a “SPECIAL PASTA MADE FROM DURUM WHEAT SEMOLINA AND WITH VEGETABLES, PRE-SALTED OR NOT”.

Naturally, there exist analogous regulations in each country and they are specific for that country.

As per the pasta commonly known and used in the kitchen, it normally has to be cooked in plenty of salted water for variable times (also long, according to the hardness of the wheat semolina used) before being seasoned and consumed. Further, pasta has, normally, a high calorie content that advises against the assumption thereof in quantities that are not moderate.

### TECHNICAL PROBLEM

It would be useful to have at disposal a type of pasta of reduced cooking times with respect to the traditional pastas; which has a reduced calorie content and greater digestibility; which has, further, different nutritional profiles suitable for the different food needs; and which, besides, can be eventually cooked without salt.

The present invention has the aim of giving an adequate answer to the needs explained above.

### DISCLOSURE OF INVENTION

It is an aim of the present invention a new type of special food pasta, eventually salted, comprising an adequate mixture of durum wheat semolina and at least one type of vegetable, as highlighted in the attached independent claim.

In such a manner, the pasta cooks in extremely inferior times with respect to the traditional products and results extremely lighter and more digestible, as also described in detail in the continuation of the present description.

Such type of pasta, which is the object of the invention, results also surprisingly suitable for being fried, something that per se is not feasible with traditional pastas, resulting in a delicious snack.

It is another aim of the present invention a procedure for the preparation of a pasta in accordance with what has been described so far, as highlighted in the attached independent claim.

Further aims of the present invention are highlighted in the attached dependent claims.

### DETAILED DESCRIPTION OF THE INVENTION

The special pasta of the present invention basically comprises:

a) a specific mixture of durum wheat semolina flours consisting of
an effective quantity of re-ground durum wheat semolina flour, said quantity being comprised between the 40% and the 80% in weight, with reference to the total weight of the mixture of the flours; preferably, comprised between the 45% and the 75% in weight, with reference to the total weight of the mixture of the flours; more preferably, comprised between the 50% and the 70% in weight, with reference to the total mixture of the flours;
an effective quantity of durum wheat semolina flour, said quantity being comprised between the 60% and the 20% in weight, with reference to the total weight of the mixture of the flours; preferably, comprised between the 55% and the 25% in weight, with reference to the total weight of the mixture of the flours; more preferably, comprised between the 50% and the 30% in weight, with reference to the total weight of the mixture of the flours;

b) an effective quantity of at least one vegetable, said quantity being comprised between the 25% and the 50% in weight, with reference to the total weight of the dough a)+b); preferably, comprised between the 30% and the 45% in weight, with reference to the total weight of the dough a)+b); more preferably, comprised between the 33% and the 42% in weight, with reference to the total weight of the dough a)+b); said vegetable being preferably selected from the group consisting of beetroot; artichoke; red cabbage; black cabbage; peas; pumpkin; asparagus; a mixture of ginger and turmeric; any type of edible mushroom, cultivated or not (for example, champignon mushrooms and/or porcini mushrooms, or any mixture of edible mushrooms, including dried mushrooms rehydrated before use); tomatoes; peppers; aubergines; thistle; celery; fennel; onion; carrots; spinaches; chard; chicory; borage; zucchini; Jerusalem artichokes; rosemary; basil; mint; sage; paprika; garlic (for example, dehydrated powder garlic); or a mixture thereof; preferably, said vegetable is selected from beetroot; artichoke; red cabbage; black cabbage; peas; pumpkin; asparagus; a mixture of ginger and turmeric; any type of edible mushroom, cultivated or not (for example, champignon mushrooms and/or porcini mushrooms, or any mixture of edible mushrooms, including dried mushrooms rehydrated before use), or a mixture thereof.

In a preferred embodiment, the special pasta of the present invention further comprises, optionally:

c) an effective quantity of kitchen food salt, said quantity being comprised between the 0.5% and the 2% in weight, with respect to the overall weight of the components; preferably, comprised between the 0.7% and the 1.8% in weight, with respect to the overall weight of the components; more preferably, comprised between the 0.9% and the 1.6% in weight, with respect to the overall weight of the components; still more preferably, comprised between the 1.1% and the 1.4% in weight, with respect to the overall weight of the components.

In a preferred embodiment, the special pasta of the present invention further comprises, optionally:

d) an effective quantity of a food vegetal oil, said quantity being comprised between the 0.05% and the 1.5% in weight, with respect to the overall weight of the components; preferably, comprised between the 0.08% and the 0.15% in weight, with respect to the overall weight of the components; more preferably, of about the 0.1% in weight, with respect to the overall weight of the components; for example, the 0.1% in weight, with respect to the overall weight of the components; said vegetal oil being selected from the group consisting of rice oil, olive oil, sunflower seed oil, corn oil, soy oil, grapevine seed oil, palm oil, and the like; preferably, rice oil.

In a particularly preferred embodiment, the special pasta of the present invention consists of:

a) a mixture of durum wheat semolina flours consisting of
the re-ground durum wheat semolina flour in a quantity comprised between the 50% and the 70% in weight, with reference to the total weight of the mixture of the flours;
the durum wheat semolina flour in a quantity comprised between the 50% and the 30% in weight, with reference to the total weight of the mixture of the flours;

b) at least one vegetable in a quantity comprised between the 33% and the 42% in weight, with reference to the total weight of the dough a)+b); said vegetable being preferably selected from the group consisting of beetroot, artichoke, red cabbage, black cabbage, peas, pumpkin, asparagus, a mixture of ginger and turmeric, mushrooms, or a mixture thereof;

c) kitchen food salt in a quantity comprised between the 1.1% and the 1.4% in weight, with respect to the overall weight of the components;

d) an effective quantity of rice oil of the 0.1% in weight, with respect to the overall weight of the components.

Advantageously, the re-ground durum wheat semolina flour absorbs moisture quicker than the normal semolina flour.

Advantageously, the durum wheat semolina flour absorbs moisture slowly, increases the mechanical seal of the pasta and improves the organoleptic features thereof.

As per the preferred vegetables of the invention, the following represent only a selected example, but not at all limiting, of vegetables to be used in the implementation of the present invention. For instance, the following are advantageously provided with the following property features:
Beetroot: it contains iron, sodium, calcium, magnesium and phosphorus (useful in case of digestive problems, they stimulate the production of gastric juices, and of anemias); further, it contains fibers (they help the intestinal function); besides, it contains also vitamins of the B group, folates, C vitamin (antioxidant).
Artichoke: it contains calcium, phosphorus, magnesium, iron and potassium (useful in case of diabetes and hypertension); further, it contains fibers (they help the intestinal function); besides, it contains chloroquine and cynarin (they help the bile flow and diuresis and contrast cholesterol); besides, it contains polyphenols (they contrast the oxidative action of free radicals and the processes of formation of tumors).
Cabbages (red and black): they contain sulfur, calcium, selenium, magnesium, potassium, phosphorus, copper, sodium (with known antitumor features to protect the intestine); further, they contain fibers (they help the intestinal function); besides, they contain also vitamins of the B group (among which folic acid), C vitamin (antioxidant), E vitamin.
Peas: they contain plenty of potassium, magnesium, iron, calcium (useful in low-calorie diets); further, they contain fibers (they help the intestinal function); besides, they contain also folic acid, C vitamin (antioxidant).
Pumpkin: it contains calcium, iron, potassium, phosphorus (it is hypocaloric and has diuretic properties); further, it contains carotenoids and peptic substances, as well as vitamins of the B group, A vitamin, C vitamin (antioxidant).
Asparagus: they contain potassium, phosphorus, calcium (diuretic and antioxidant properties); further, they contain fibers (they help the intestinal function); besides, they contain also folic acid, A vitamin, C vitamin (antioxidant).
Ginger: it contains calcium, sodium, phosphorus, iron, magnesium, potassium, manganese (it has anti-inflammation properties and stimulates the digestion); further, it contains fibers (it helps the intestinal function); besides, it contains also B vitamin, C vitamin (antioxidant), E vitamin.
Turmeric: it contains a series of active principles, among which curcumin (it has anti-inflammation, depurative, antioxidant, antitumor properties).

In any case, the employ of other vegetables, taken singularly or in an adequate combination of them and/or with the previously described vegetables, falls totally within the field of the scope of the present invention and is clearly within the reach of the technician/cook expert in the field.

Totally unexpectedly, the specific mixture of the flours described above, in combination with the vegetable/s indicated, and the reciprocal quantity/ties of the same have conferred the resulting pasta the desired features described before and in the continuation of the present description. In brief, the specific mixture above has conferred the resulting pasta a very short cooking time (comprised, for instance, from 1-1,5 min to a maximum of 3-4 min); it has allowed, further, to obtain a low-calorie product (see final Chart 1), provided with greater digestibility and with a high nutritional content, suitable for the different food needs; besides, the pasta can be eventually cooked without salt (in the version in which such dough is already salted) or it can also be fried.

### Preparation of the Pasta of the Invention

The procedure to prepare the special pasta of the present invention preferably comprises the following phases:

i) steam the vegetable/s at low temperature (preferably, at 80° C.-98° C.) in a traditional apparatus suitable for steam cooking (for example, in a steam oven) for the necessary time to obtain the desired cooking; eventually, in case vegetables with a greater content of water have to be cooked, adding a further dry cooking phase of at least 10 min to the preceding cooking; preferably, in this case, the optimal working can be done in a combined oven;

ii) subsequently, make the cooked vegetables of phase i) cool at environmental temperature and reduce them to the consistency of a purée with an adequate traditional cutter, optionally adding (if desired or if considered necessary) salt and/or vegetal oil (preferably, rice oil);

iii) aside, mix the flours, in the desired quantity, in a suitable traditional kneading machine at environmental temperature; then, add the purée of vegetable/s derived from phase ii) and knead at environmental temperature for a time not superior to the min, preferably not superior to the 7 min, more preferably, not superior to the 4 minutes;

iv) put the dough derived from phase iii) in a traditional extruder, suitable for the preparation of the pasta, in such quantities as to be able to be extruded in a maximum time of 8-13 min, preferably of no more than 10 min, and extrude the dough at a temperature of <55° C., preferably <50° C., still more preferably comprised between 45-48° C. [this because we work at extreme moisture levels and the pasta in exit phase from the extruder has to be subject to an air jet at environmental temperature to take the surface moisture off];

v) dry the extruded pasta in phase iv) for a period of time preferably comprised between 1 h and 8 hs, more preferably from 2 hs to 6 hs, under a laminar air motion/flow at a temperature inferior to the 35° C., for instance, at environmental temperature.

At the end of said phase v), if a shorter drying time has been adopted (for example, from 1 h to 3 hs), the pasta obtained normally has a residual moisture almost equal or slightly superior to the 24%. On the contrary, when a longer drying time is adopted (for example, from 5 hs to 8 hs), the pasta obtained has a residual moisture of about the 12.5%.

The optimal range of moisture is usually intermediate between such extreme values.

In any case, the moisture is not binding for the purposes of the conservation of the product because, after the drying, the procedure of production foresees an optional further phase vi) of reduction of the temperature of the pasta to about −24° C. followed by the packing (traditional) and by the subsequent conservation in an appropriate container (for instance, a freezer) at a strongly negative temperature (like a temperature comprised between the −18 and the −24° C., for example of about −21° C.).

In a preferred embodiment of the invention, the drying phase v) above is followed by a phase vi) of reduction of the temperature to =24° C., followed by a phase of conservation of the product finished and packaged at about −21° C.

All this allows, as explained here below, to choose freely between using the pasta conventionally (cooking it in a pot or in a pasta cooker) or frying it (in a frying machine, eventually also industrial, or in a frying pan) just extracted from the freezer.

Leaving as it is that the pasta of the present invention can be commercialized and consumed either fresh (with moisture of ≥24%) or dried (with a maximum moisture of about the 12.5%), in a particularly preferred embodiment, said pasta can be commercialized as frozen pasta, which permits to set/confer a range of moisture also intermediate between the one of fresh pasta and the one of dried pasta.

This choice, in combination with the desired ingredients (in particular, the specific mixture of the flours above and the mixture with the vegetable/s, as described above) and with the procedure of production to obtain it (as described above), unexpectedly render the pasta of the present invention idoneous not only for the classic cooking in water (with or without the addition of salt as desired), in a pot or in a pasta cooker, but also particularly suitable/perfect to be collected from the freezer and fried as it is (for example, in a frying machine, also industrial, or in a frying pan) to then leave it to cool and use it as a salty snack immediately or almost immediately, or as a packaged salty snack (for instance in a modified atmosphere or, anyway, with analogous precautions to those of the common salty snacks, such as potato chips) to be sold through the great distribution to be consumed alone or combined, for instance, with a cocktail. In this last case, it has been found that the fried pasta of the invention, in its form of snack, had a nutritional content advantageously superior to that of any type of fried snack in commerce (indifferently from the fact that the same is based on potatoes, corn, sintered products of potato starch, and the like).

As further described in detail below, the pasta of the present invention provides advantageous relevant technical effects also in its traditional use, when it is cooked in water (salted or not salted), in a pot or in a pasta cooker. In fact, it has been demonstrated that it reduces significantly the cooking times (see Chart 1 below), allows not to salt the water in which it has to be cooked, presents nutritional profiles that are significant and different/connected to the type of vegetable/s used inside of it, preserving (thanks precisely to the very short cooking time) in great part the nutrients and the beneficial properties thereof for the organism.

Moreover, (always thanks to the specific precautionary combination of the ingredients described above, the flours and the vegetable/s used) said pasta has demonstrated to have less calories with respect to the normal semolina pasta and a greater digestibility; therefore, it has resulted suitable also for people undergoing a low-calorie diet, for diabetic people, for children that do not love vegetables and that can thus assimilate the nutritional principles thereof eating pasta.

The pasta of the present invention can be realized in any desired format (just as a way of example, but not limiting, of the short type such as gramigna, sedani, maccheroni, penne, tortiglioni, paccheri, fusilli, untwisted fusilli, cavatielli, orecchiette and so on, or of the long type such as spaghetti, spaghettini, bucatini, tagliolini, tagliatelle, guitar spaghetti and so on) and introducing the most diverse vegetables, (the vegetables cited as nutritionally favourite in the present description are only an example, absolutely not limiting, of the wide possibilities of the equivalent variations/differentiations that can be provided by the technician/cook expert in the desired selection of the vegetables, according to the nutritional quality thereof or also only aesthetic and/or organoleptic; for instance, according to the colour, the fragrance and the taste/flavour that the same confer to the pasta.

Advantageously, further, the introduction of the vegetable/s has rendered superfluous the use of the water as ingredient in the phase of dough of the ingredients (as described before, eventually, the addition of a small quantity of oil is enough (preferably rice oil).

The nature of the ingredients that can be used allows to find them in the market, also certified as organic, therefore such pasta can be advantageously commercialized both in the normal version and in the bio (organic) version.

The use of gluten-free ingredients (for instance, the flours) is advantageously possible, producing in such a way a pasta that is suitable for the food needs of the people that suffer from celiac disease.

In the following Chart 1 are shown in summary form, for the reader's convenience, the main technical features of the special pasta of the present invention, in comparison with analogous features of a number of traditional commercial pastas.

Chart 1—Features of the pasta of the present invention in comparison with the traditional commercial pasta:

| A sample of pasta of | | |
|---|---|---|
| the invention, salted | | Comparison notes with |
| and seasoned with rice | | the values obtained |
| oil, containing the 31% | | from a selection of |
| of beetroot*** and with | Features of the pasta | pastas purchased in |
| a residual moisture | of the invention | commerce (min-max |
| superior to the 24%* | (detected values) | values) |
| Drying time | from 2 hs to 6 hs | — |
| Cooking time in a pasta | From a minimum of 1-1.5 min | The normal semolina |
| cooker of the | to a maximum | pasta requires from |
| professional type | of 3-4 min according | 7 to 11 (but also 15-18) |
| | to the format of the | min |
| | pasta; the optimal | |
| | average time is of | |
| | about 2 min for all | |
| | types of pasta | |
| | The water in the | The water MUST BE |
| | pasta cooker MUST NOT | salted and it is |
| | be salted | almost impossible to |
| | | maintain constant the |
| | | concentration of the |
| | | salt in the pasta |
| | | cooker |
| NUTRITIONAL VALUES | Sample of 100 gr | Commercial pasta (100 gr) |
| | (with moisture of | |
| | >24%*) | |
| | [between brackets the | |
| | values for the same | |
| | sample, calculated at | |
| | the 12.5% of moisture**] | |
| Proteines (gr) | 10.15 (12.18) | 12-14.5 |
| Fats (gr) | 0.42 (0.504) | 1.5-2 |
| (of which saturated | 0.11 (0.132) | 0.1-0.3 |
| fatty acids) (gr) | | |
| Carbohydrates (gr) | 51.1 (61.32) | 69.5-74 |
| (of which sugars) (gr) | 8.3 (9.96) | 2.9-3.5 |
| Total food fiber | 6.0 (7.2) | 2.9-3.0 |
| (gr) | | |
| Energy (Kcal) | 261 (313.2) | 356-362 |
| Kitchen salt (gr) | 1.12 (1.344) | 0.005-0.04 |
| Minerals, Vitamins, | (as reported before, | — |
| other nutrients | qualitatively) | |
| Frying time, if applied | From 1 min to 2 min | Not applicable |
| in frying machine at | | (neither using fresh |
| 170° C. | | pasta before drying) |

*= at the 30% of moisture
**considering the moisture value of the pasta at the 30%, the values relative to the 12.5% of moisture have been calculated using the formula of the weight loss (100-initial moisture)/(100-final moisture) = Final weight % that in the present case becomes (100-30)/(100-12.5) = 0.8. As by drying only the moisture is lost and not the other substances, the values relative to the various substances of the 100 g of initial product have been re-parameterized multiplying them by 1.2. For instance, (carbohydrates in 100 g of pasta at the 12.5% of moisture) = (carbohydrates in 100 g of pasta at the 30% of moisture) × 1.2 because from 100 g of pasta at the 30%, once dried at the 12.5%, there remain 80 g.
***the present sample of the test has been selected with a minimum content of vegetable (31%), in fact inferior with respect to the particularly preferred values of the invention (33%-42%), to highlight that the significantly positive nutritional values detected are surely better, with respect to those of the traditional pastas, already in the cases that should be considered “less favourite”. It results clear, therefore, that for superior contents of vegetable said nutritional values will result even better.

It is evident from the data and from the considerations reported above in Chart 1 which significant and unexpected advantages the pasta of the present invention has given to the state of the art relative to the special pastas, in particular to those with vegetables.

### INDUSTRIAL APPLICABILITY

The special food pasta, optionally salty, and with the vegetables of the present invention, has demonstrated that it can provide advantageous features with respect to the traditional pasta, such as inferior cooking time in water (salted or not salted), an inferior calorie content and a greater digestibility, in addition to an improved, significant differentiated supply of useful nutrients for the organism. Further, it provides also the possibility of being conserved in freezing state and subsequently fried at the moment of the consumption, or to be further conserved/packaged as such and used as a snack.

The invention claimed is:

1. A food pasta, comprising:
a) a mixture of durum wheat semolina flours consisting of:
an effective quantity of re-ground durum wheat semolina flour comprised between 40% and 80% in weight, with reference to a total weight of the mixture of the durum wheat semolina flours; and
an effective quantity of durum wheat semolina flour comprised between 60% and 20% in weight, with reference to the total weight of the mixture of the durum wheat semolina flours; and
b) an effective quantity of at least one vegetable comprised between 25% and 50% in weight, with reference to total weight a)+b).

2. The food pasta of claim 1, further comprising:
c) an effective quantity of kitchen food salt comprised between 0.5% and 2% in weight, with respect to the total weight.

3. The food pasta of claim 1, further comprising:
d) an effective quantity of a food vegetal oil, said quantity being comprised between 0.05% and 1.5% in weight, with respect to the total weight.

4. The food pasta of claim 1, wherein said at least one vegetable is selected from the group consisting of beetroot, artichoke, red cabbage, black cabbage, peas, pumpkin, asparagus, a mixture of ginger and turmeric, an edible mushroom, tomatoes, peppers, eggplant, thistle, celery, fennel, onion, carrots, spinach, chard, chicory, borage, zucchini, rosemary, basil, mint sage, Jerusalem artichokes, or a mixture thereof.

5. The food pasta of claim 1, wherein said at least one vegetable is selected from the group consisting of beetroot, artichoke, red cabbage, black cabbage, peas, pumpkin, asparagus, a mixture of ginger and turmeric, any type of edible mushroom or a mixture thereof.

6. The food pasta of claim 3, wherein said food vegetal oil is selected from the group consisting of rice oil, olive oil, sunflower seed oil, corn oil, or soy oil.

7. The food pasta of claim 6, wherein said oil is rice oil.

8. The food pasta of claim 1, consisting of:
a) the mixture of durum wheat semolina flours consisting of:
the re-ground durum wheat semolina flour in a quantity comprised between 50% and 70% in weight, with reference to the total weight of the mixture of the flours;
the durum wheat semolina flour in a quantity comprised between 50% and 30% in weight, with reference to the total weight of the mixture of the durum wheat semolina flours;
b) the at least one vegetable in a quantity comprised between 33% and 42% in weight, with reference to the total weight of a)+b); said vegetable being selected from the group consisting of beetroot, artichoke, red cabbage, black cabbage, peas, pumpkin, asparagus, a mixture of ginger and turmeric, any type of edible mushroom, or a mixture thereof;
c) kitchen food salt in a quantity comprised between 1.1% and 1.4% in weight, with respect to the total weight; and
d) a quantity of rice oil in 0.1% in weight, with respect to total weight.

9. A procedure for preparing a pasta, comprising:
i) preparing a mixture of durum wheat semolina flours consisting of:
an effective quantity of re-ground durum wheat semolina flour comprised from 40% and 80% in weight, with reference to a total weight of the mixture of the durum wheat semolina flours;
an effective quantity of durum wheat semolina flour comprised from 60% and 20% in weight, with reference to the total weight of the mixture of the durum wheat semolina flours;
ii) preparing an effective quantity of at least one vegetable comprised between 25% and 50% in weight, with reference to the total weight of a)+b);
iii) steaming the at least one vegetable; then, letting the steamed vegetables cool at environmental temperature and reducing the at least one vegetable to a consistency of a puree;
iv) mixing the mixture of the durum wheat semolina flours with the puree of the at least one vegetable and kneading to obtain a dough;
v) putting the dough in an extruder configured to prepare the pasta and extrude the dough; and
vi) drying the extruded dough.

10. The procedure of claim 9, wherein one or both of salt or vegetal oil are added in step iii).

11. The procedure of claim 9, wherein in phase v) the dough is extruded in a maximum time of 10 min.

12. The procedure of claim 9, wherein in phase vi) the extruded dough is dried in a time comprised between 2 hrs and 6 hrs.

13. The procedure of claim 9, further comprising:
vii) reducing the temperature to −24° C., followed by a step of packaging and conserving the pasta at about −21° C.

14. The procedure of claim 9, wherein drying the extruded dough comprises drying with an air jet at environmental temperature to remove surface moisture.

15. The procedure of claim 14, wherein the extruded dough is dried to a moisture level equal to or greater than 24% for commercialization as fresh pasta.

16. The procedure of claim 14, wherein the extruded dough is dried to a moisture level of about 12.5% for commercialization as dried pasta.

17. The procedure of claim 14, wherein the extruded dough is dried to a moisture level between 12.5% and 24% and subsequently frozen.
